(19) United States
(12) Patent Application Publication
(10) Pub. No.: US 2025/0361363 A1
(43) Pub. Date: Nov. 27, 2025

(54) SELF-HEALING POLYMER COMPOUND, MANUFACTURING METHOD THEREOF, AND RECYCLING METHOD THEREOF

(71) Applicant: KOREA INSTITUTE OF SCIENCE AND TECHNOLOGY, Seoul (KR)

(72) Inventors: Tae Ann KIM, Seoul (KR); Ju Ho LEE, Seoul (KR); Jae Hong KIM, Seoul (KR); Junghwan BYUN, Seoul (KR); Kyungjune CHO, Seoul (KR); Dongju LEE, Incheon (KR)

(21) Appl. No.: 18/886,110

(22) Filed: Sep. 16, 2024

(30) Foreign Application Priority Data
May 22, 2024 (KR) 10-2024-0066517

(51) Int. Cl. C08G 75/06

(52) U.S. Cl. CPC C08G 75/06; C08G 2250/00; C08G 2350/00

(57) ABSTRACT

This specification discloses a self-healing polymer compound that can be chemically recycled and a method for preparing the same, and a method for recycling the same. More specifically, disclosed are a polymer compound that is not only capable of self-healing, thereby delaying the replacement period, but also composed of molecules that can be recovered as a raw material again, thereby making it possible to save a production cost of the raw material; a method for preparing the same; and a method for recycling the same.

### DESCRIPTION OF GOVERNMENT-SPONSORED RESEARCH

This research was conducted with the support from the Ministry of Science and ICT of the Republic of Korea under the supervision of the National Science and Technology Research Council. The name of the research business is the National Science and Technology Research Council's research and operation expense support (major project expense), and the name of the research project is to develop material and component technology for high frequency/high power electromagnetic wave solution to secure the reliability of future mobility operation (Unique Project identification number: 1711202512).

### CROSS REFERENCE TO RELATED APPLICATION

The present application claims the priority of Korean Patent Application No. 10-2024-0066517, filed on May 22, 2024, the entire contents of which are incorporated herein for all purposes by this reference.

### BACKGROUND OF THE INVENTION

### Field of the Invention

This specification discloses a self-healing polymer that can be chemically recycled and an application thereof as a shock absorber (Closed-loop chemically recyclable and self-healing polymers and their applications in high energy dissipating materials).

### Description of the Related Art

The disulfide group, which has been known as one of the representative dynamic covalent bonds, is widely used to ensure self-healing, re-molding, and re-processing of thermosetting polymer materials, but there is no case of utilizing activation of the corresponding dynamic bonds in maximizing absorption characteristics of the impact energy.

Exchange reaction of the disulfide group is the dynamic covalent bonds whose activation degree can be very widely adjusted depending on the structure of a polymer matrix and the presence or absence of a catalyst. Although there have been studies examining absorption characteristics of the impact energy by utilizing polymer materials having different dynamic covalent bonds, it has been unknown how a degree of activation of the dynamic bonds affects energy dissipation.

In addition, the shock-absorbing materials are frequently exposed to continuous or strong energy, and as a result, in case previously reported shock absorbers are used, the cycle of damage and deformation is extremely short so that frequent replacement is inevitable, which cause a problem that is not economical.

### SUMMARY OF THE INVENTION

According to an embodiment, the present disclosure is to provide a polymer compound that is not only capable of self-healing, thereby delaying the replacement period, but also composed of molecules that can be recovered as a raw material again, thereby making it possible to save a production cost of the raw material.

In an exemplary embodiment, the present disclosure provides a polymer compound comprising:
a structural unit represented by the formula 1 below;
a structural unit represented by the formula 2 below; and
an amine base.

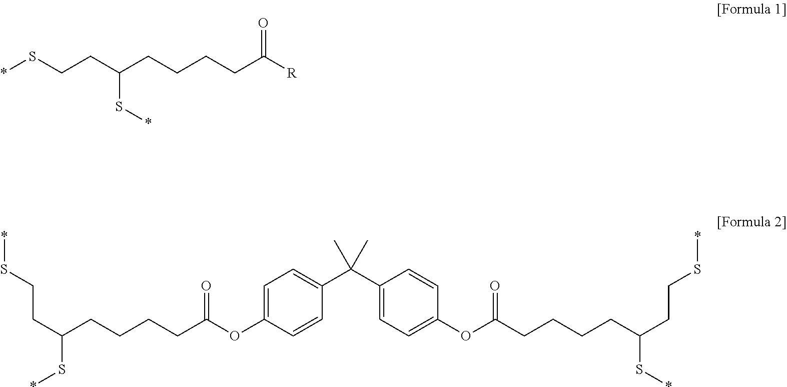

In the formula 1, R is represented by any one of the following formulas:

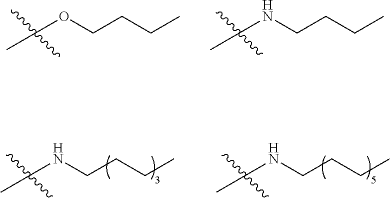

In an embodiment, the amine base may be a bi-or polycyclic amine base.

In an embodiment, the amine base may contain one or more selected from the group consisting of 1,8-diazabicyclo[5.4.0]-7-undecane (DBU), 1,5-diazabicyclo[4.3.0]-5-nonene (DBN)), 1,4-diazabicyclo[2.2.2]octane (DABCO), 1,5,7-triazabicyclo[4.4.0]dec-5-ene (TBD), and 7-methyl-1,5,7-triazabicyclo[4.4.0]dec-5-ene (MTBD).

In an embodiment, a content of the amine base may be 3% by weight or more based on the total weight of the polymer compound.

In an embodiment, the polymer compound may further comprise a photoinitiator.

In an embodiment, the photoinitiator may contain one or more selected from the group consisting of phenyl-bis(2,4,6-trimethylbenzoyl)-phosphine oxide, (2,4,6-trimethylbenzoyl)-diphenyl-phosphine oxide, phenyl-(2,4,6-trimethylbenzoyl)-phosphinic acid ethyl ester, bis-acylphosphine oxide, bis(2,6-dimethoxybenzoyl)-(2,4,4-trimethyl-pent-1-yl) phosphine oxide, bis(2,4,6-trimethylbenzoyl)-(2,4-dipentoxyphenyl)phosphine oxide, and trisacylphosphine oxide.

In an embodiment, the polymer compound may be semi-crystalline or amorphous.

In an embodiment, the polymer compound may be used to absorb a shock wave.

In an embodiment, the polymer compound can be restored to its original mechanical properties within 30 minutes after applying mechanical shock.

In another exemplary embodiment, the present disclosure provides a method for preparing the above-described polymer compound, the method comprising the steps of:
obtaining a crosslinked polymer by mixing a compound represented by the formula 1-1 below with a compound represented by the formula 2-1 below; and
adding an amine base to the crosslinked polymer.

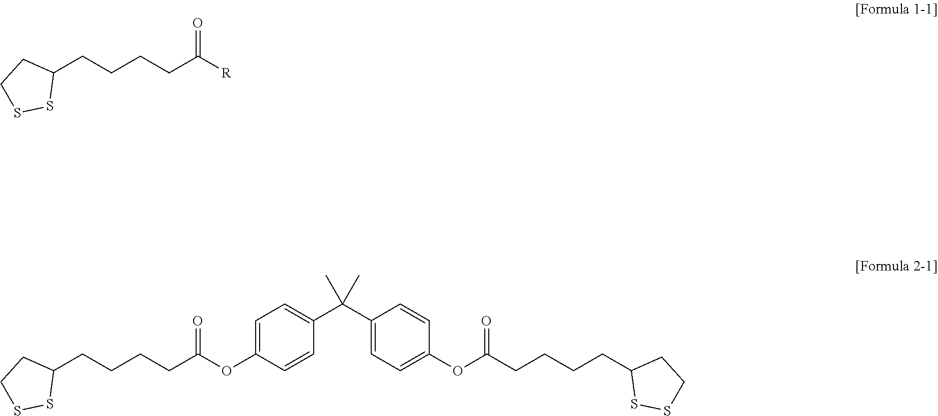

In the formula 1-1, R is represented by any one of the following formulas:

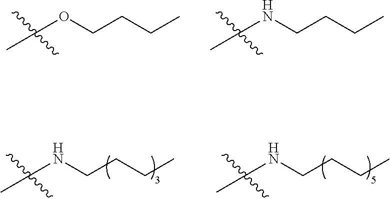

In an embodiment, the method may further comprise the step of, before obtaining the crosslinked polymer, obtaining the compound represented by the formula 1-1 by reacting a lipoic acid with a compound represented by any one of the following formulas:

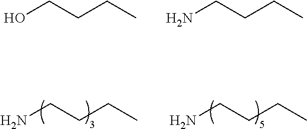

In an embodiment, the method may further comprise the step of, before obtaining the crosslinked polymer, obtaining the compound represented by the formula 2-1 by reacting a lipoic acid with bisphenol A.

Another still exemplary embodiment, the present disclosure provides a method for recycling the above-described polymer compound, the method comprising the steps of:
dissolving the polymer compound in a solution containing an amine base; and
separating a compound represented by the formula 1-1 below and a compound represented by the formula 2-1 below from the above solution.

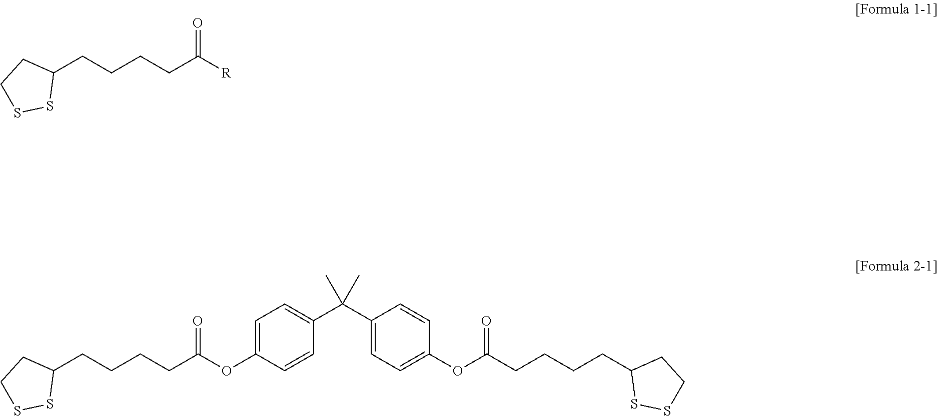

In the formula 1-1, R is represented by any one of the following formulas:

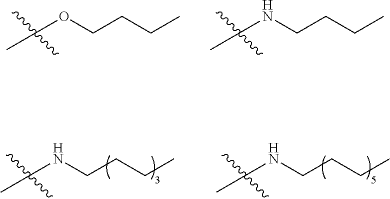

Since the monomer and the crosslinker included in the polymer compound according to an embodiment of the present disclosure are all made using as a parent molecules of a pentagonal ring structure (dithiolane) containing disulfide, which is dynamic bonds, numerous dynamic bonds are formed throughout the polymer matrix, whereby the polymer compound can exhibit very excellent energy absorption ability compared to most polymer materials.

Further, in case the polymer compound according to an embodiment of the present disclosure has been damaged due to external impact, the polymer compound can not only quickly repair the damage through activity of the dynamic covalent bonds, but also converted and recover back to raw materials through a chemical recycling method, whereby its service life can be dramatically extended and its production costs can be saved in the long run.

Furthermore, the polymer compound according to an embodiment of the present disclosure can be applied in protective fields where excellent self-healing ability and high energy dissipation characteristics are particularly important, and in most industrial fields that require buffering and attenuation capabilities.

### BRIEF DESCRIPTION OF THE DRAWINGS

FIG. 1 shows binding and structural characteristics of a polymer compound according to an embodiment of the present disclosure.

FIGS. 2, 3 and 4 are schematic diagrams showing a method for synthesizing a polymer compound according to an embodiment of the present disclosure.

FIG. 5 shows the results of measuring a glass transition temperature of a linear polymer compound in an example of the present disclosure.

FIGS. 6A, 6B, and 6C each show the results of observing rheological properties of a linear polymer compound at a very high frequency in an example of the present disclosure.

FIG. 7 shows the results of observing shock wave absorption characteristics of a linear polymer compound in an example of the present disclosure.

FIG. 8 shows the results of observing self-healing characteristics of a crosslinked polymer compound in an example of the present disclosure.

FIG. 9 shows the results of observing G′ and G″ values depending on DBU contents of a crosslinked polymer compound in an example of the present disclosure.

FIG. 10 shows the results of observing shock wave absorption characteristics depending on DBU contents of a crosslinked polymer compound in an example of the present disclosure.

FIG. 11 shows the results of comparing the characteristics between a crosslinked polymer compound according to an example of the present disclosure and previously known shock wave-absorbing materials.

FIG. 12 shows the results of restoring a crosslinked polymer compound according to an example of the present disclosure to a monomer and a crosslinker of a parent.

### DETAILED DESCRIPTION OF THE INVENTION

Hereinafter, preferred embodiments of the present disclosure will be described in detail with reference to the attached drawings.

Since the embodiments of the present disclosure disclosed herein are described only for illustrative purposes, they may be implemented in various forms and should not be construed to be limited to the embodiments described herein.

The present disclosure can be applied to various changes and may take various forms. Therefore, it should be understood that the embodiments are not intended to limit the present disclosure to a specific disclosed form, but cover all changes, equivalents, or substitutes included in the spirit and technical scope of the present disclosure.

In this specification, in case a certain part “includes” a certain component, this means that the certain part may further include other components rather than excluding the other components, unless specifically stated to the contrary.

Hereinafter, exemplary embodiments of the present disclosure will be described in detail.

In this specification,

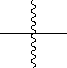

means a site connected to another substituent.

In an exemplary embodiment, the present disclosure provides a polymer compound comprising:
a structural unit represented by the formula 1 below;
a structural unit represented by the formula 2 below; and
an amine base.

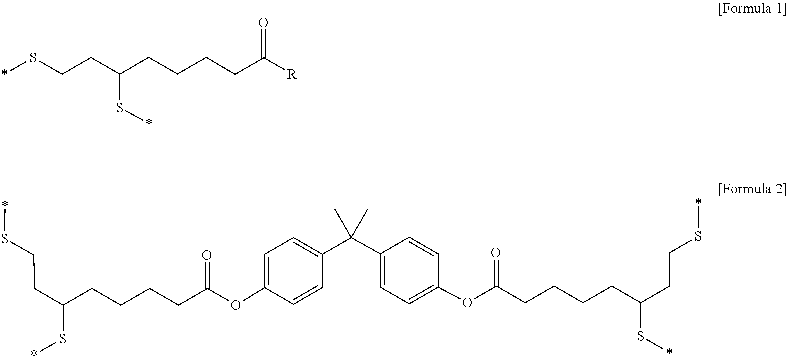

In the formula 1, R is represented by any one of the following formulas:

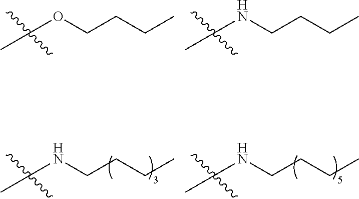

In the formulas 1 and 2, * refers to a site connected to another substituent.

When a certain energy is given from an outside, the reversible crosslinking is subjected to an exchange reaction and absorbs the energy. An embodiment of the present disclosure is to apply such energy absorption characteristics to design materials capable of alleviating mechanical energy such as a shock wave.

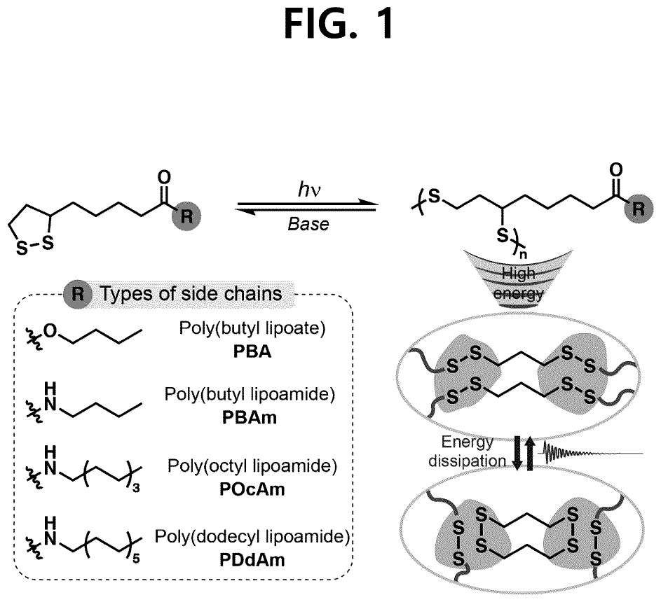

The polymer compound according to an embodiment of the present disclosure can be prepared based on a monomer having a pentagonal ring structure containing disulfide bonds (S—S) as shown in FIG. 1, wherein the linear polymer is produced by adding a small amount of a photoinitiator to the monomer and then irradiating it with a ultraviolet light, and the linear polymer can be restored back to the monomer under an appropriate basic condition. Therefore, the polymer compound is a chemically recyclable material.

Specifically, the thermal and mechanical properties of the polymer can be controlled by adjusting a side chain group of the pentagonal ring monomer, and the energy absorption ability can also be controlled when high physical energy such as the shock wave is applied. In addition, when the physical energy is applied to the polymer, the disulfide bonds are quickly exchanged so that the polymer can have a structure that can absorb additional energy.

In other words, by using a single dynamic covalent polymer network without a heterogeneous filler, uniform energy dissipation characteristics can be maintained at all sites of the polymer, while the presence of dynamic covalent bonds such as S—S bonds as shown in FIG. 1 allows for self-healing against a damage and continuous adaptation to deformation, and the crosslinked polymer formed by reversible covalent bonds makes possible it to remold the polymer.

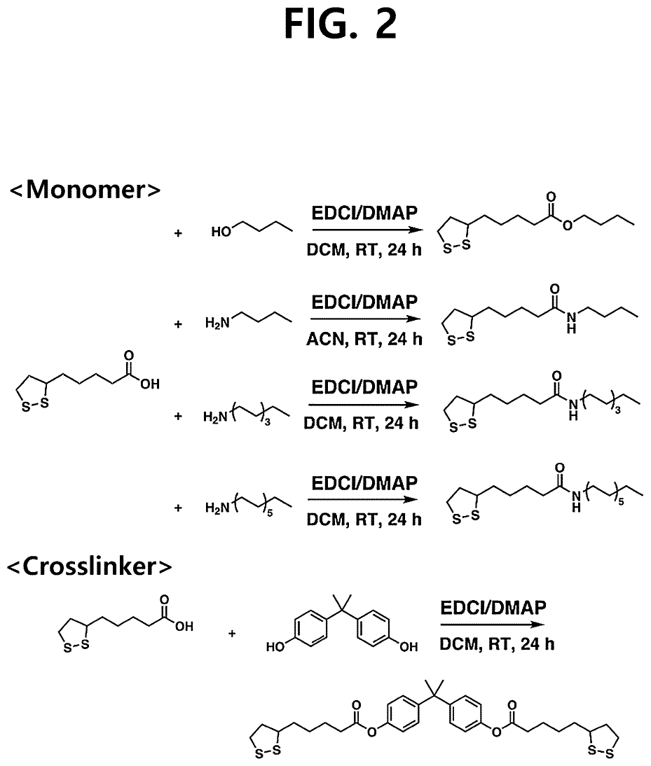

Referring to FIG. 2, the polymer compound can be used for all types of monomers that have a pentagonal ring structure (dithiolane) containing disulfide. If the monomer has a carboxylic acid at the end, a length of the side chain or the presence or absence of a hydrogen bonding can be adjusted through esterification or amidification reactions.

Further, as in the crosslinker of FIG. 2, it is also possible to synthesize molecules that can serve as the crosslinker by forming molecules containing dithiolane at both ends through a substitution reaction with molecules having a hydroxyl group or amine at both ends.

For example, the polymer compound may be represented by the following formula 3 or formula 3-1.

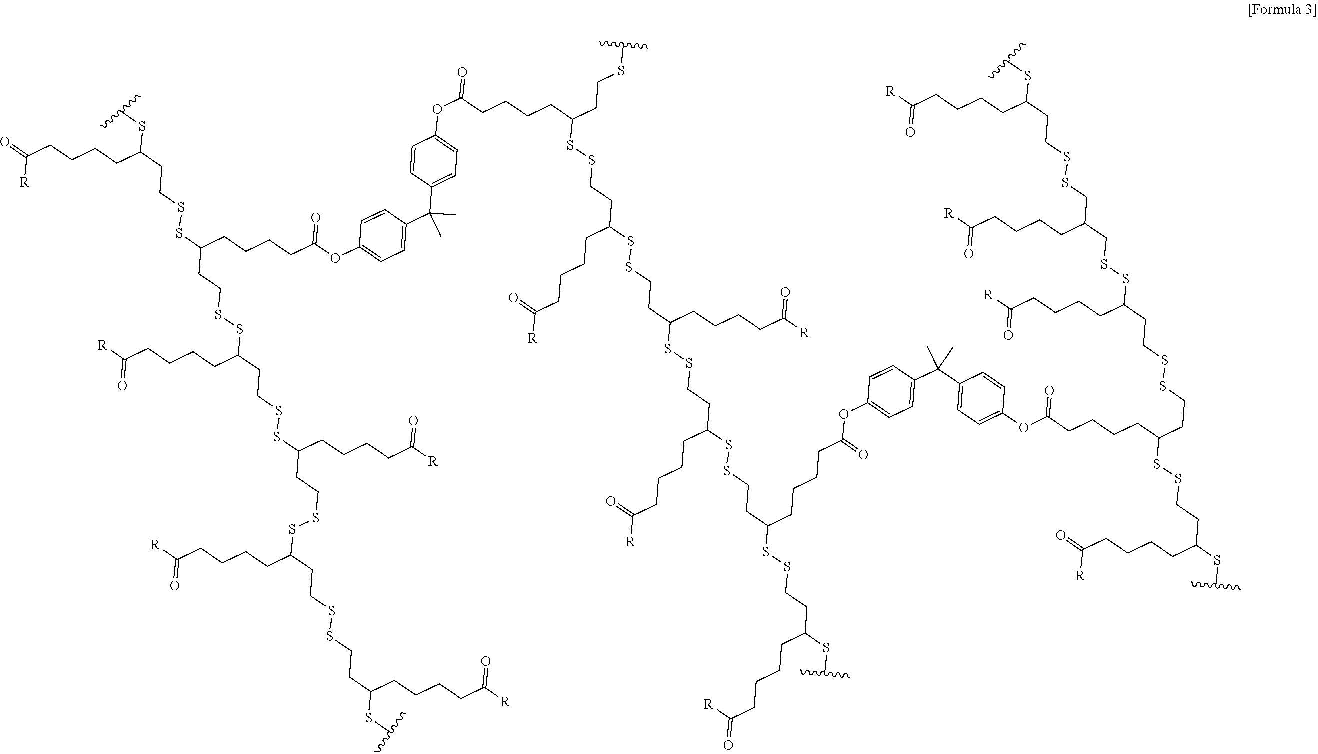

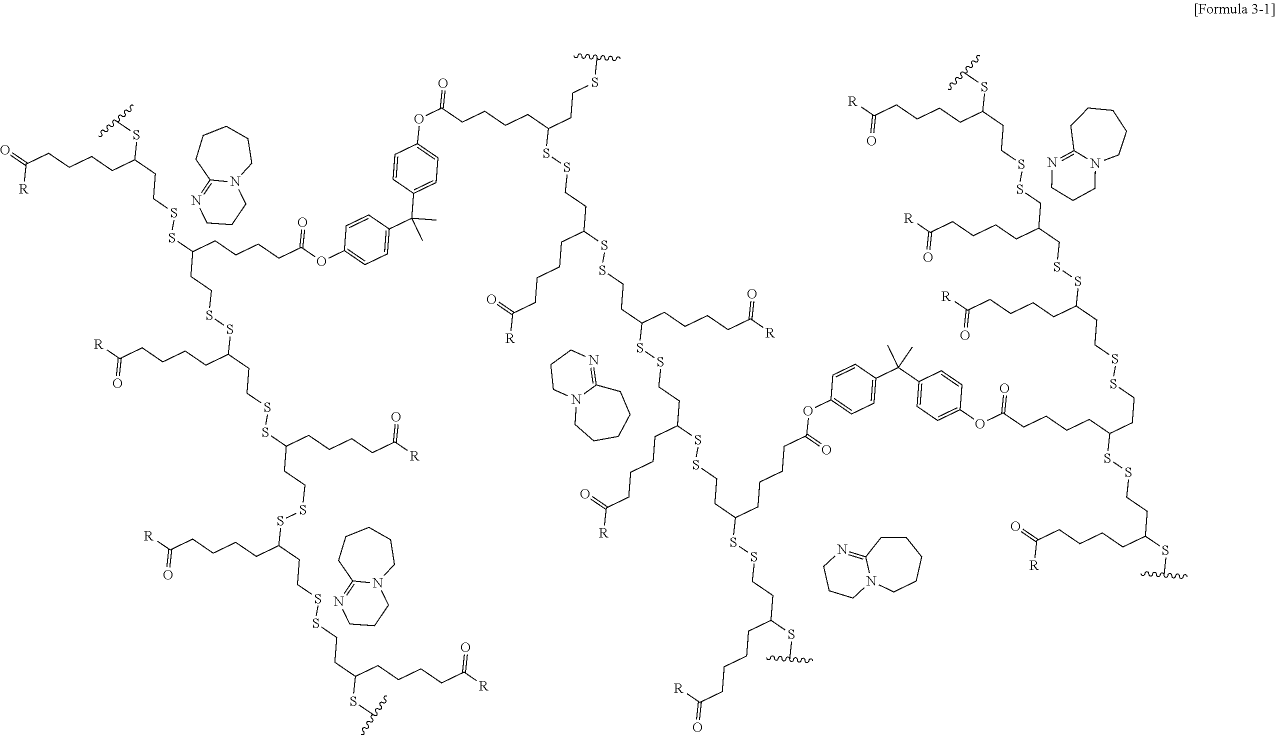

In an embodiment, the amine base may include any of all nucleophiles having an amine group, regardless of primary, secondary, or tertiary amine. The higher basicity or nucleophilicity, the more active the disulfide exchange reaction can be occurred by attacking the S—S bonds.

In an embodiment, the amine base may be a bi-or polycyclic amine base.

In an embodiment, the amine base may contain one or more selected from the group consisting of 1,8-diazabicyclo[5.4.0]-7-undecane (DBU), 1,5-diazabicyclo[4.3.0]-5-nonene (DBN)), 1,4-diazabicyclo[2.2.2]octane (DABCO), 1,5,7-triazabicyclo[4.4.0]dec-5-ene (TBD), and 7-methyl-1,5,7-triazabicyclo[4.4.0] dec-5-ene (MTBD).

In an embodiment, a content of the amine base may be 3% by weight or more based on the total weight of the polymer compound.

According to an embodiment of the present disclosure, energy dissipation characteristics can be maximized by adjusting activation energy of the disulfide bonds using the above content of the amine base.

For example, the content of the amine base may be 3% by weight or more, 4% by weight or more, 5% by weight or more, 6% by weight or more, 7% by weight or more, 8% by weight or more, 9% by weight or more, 10% by weight or more, 11% by weight or more, 12% by weight or more, 13% by weight or more, 14% by weight or more, or 15% by weight or more, based on the total weight of the polymer compound, and may be 20% by weight or less, 19% by weight or less, 18% by weight or less, 17% by weight or less, 16% by weight or less, 15% by weight or less, 14% by weight or less, 13% by weight or less, 12% by weight or less, 11% by weight or less, 10% by weight or less, 9% by weight or less, 8% by weight or less, 7% by weight, 6% by weight or less, 5% by weight or less, or 4% by weight or less, based on the total weight of the polymer compound. If the content of the amine base is less than 3% by weight, the exchange reaction rate does not effectively increase to exhibit only self-healing characteristics at a high temperature. If it is more than 20% by weight, almost all of the amine base is converted to the monomer, thereby making it difficult to maintain the polymer state.

In an embodiment, the polymer compound may further comprise a photoinitiator.

In an embodiment, the photoinitiator may contain one or more selected from the group consisting of phenyl-bis(2,4,6-trimethylbenzoyl)-phosphine oxide, (2,4,6-trimethylbenzoyl)-diphenyl-phosphine oxide, phenyl-(2,4,6-trimethylbenzoyl)-phosphinic acid ethyl ester, bis-acylphosphine oxide, bis(2,6-dimethoxybenzoyl)-(2,4,4-trimethyl-pent-1-yl) phosphine oxide, bis(2,4,6-trimethylbenzoyl)-(2,4-dipentoxyphenyl)phosphine oxide, and trisacylphosphine oxide.

In an embodiment, the polymer compound may be semi-crystalline or amorphous.

If an exothermic peak generated when crystals are formed appears on DSC or an endothermic peak generated when the crystals are melted appears on DSC, it can be said to be a semi-crystalline polymer. If there are no such endothermic/exothermic peaks, it can be classified as an amorphous polymer. In terms of shock absorption, the higher fluidity of the polymer chains, the more advantageous it is.

The semi-crystalline polymer has a crystalline portion, that is, a region where the polymer chains are closely aligned, and thus the fluidity of the polymer is relatively lower than that of the amorphous polymer. For this reason, it can be seen that the semi-crystalline polymer containing some crystalline regions has a lower shock wave absorption ability than that of the amorphous polymer.

In an embodiment, the polymer compound may be used to absorb a shock wave.

In an embodiment, the polymer compound can be restored to its original mechanical properties within 30 minutes after applying mechanical shock.

For example, the polymer compound can be restored to its original mechanical properties within 30 minutes after the mechanical impact is applied at a room temperature.

In another exemplary embodiment, the present disclosure provides a method for preparing the above-described polymer compound, the method comprising the steps of:
obtaining a crosslinked polymer by mixing a compound represented by the formula 1-1 below with a compound represented by the formula 2-1 below; and
adding an amine base to the crosslinked polymer.

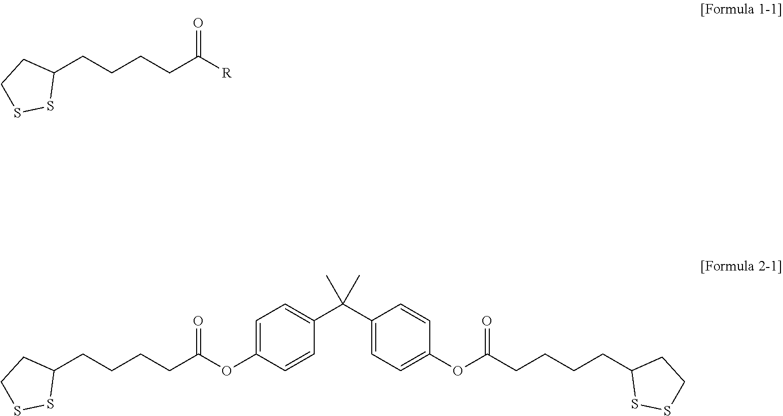

In the formula 1-1, R is represented by any one of the following formulas:

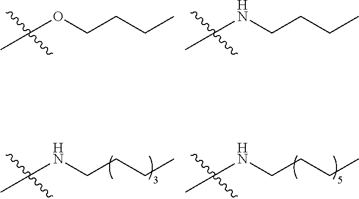

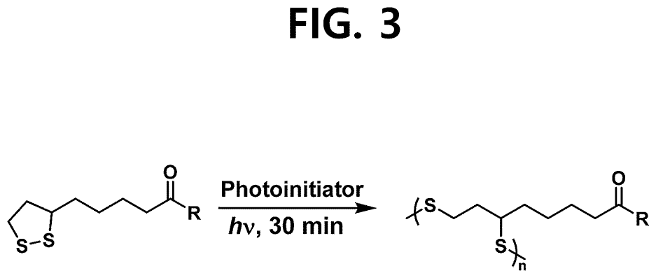

As shown in FIG. 2, the monomer and the crosslinker can be prepared separately, and the dithiolane monomer synthesized as shown in FIG. 3 can be synthesized into a linear polymer through photopolymerization. All of them can be polymerized in a similar manner regardless of the monomer.

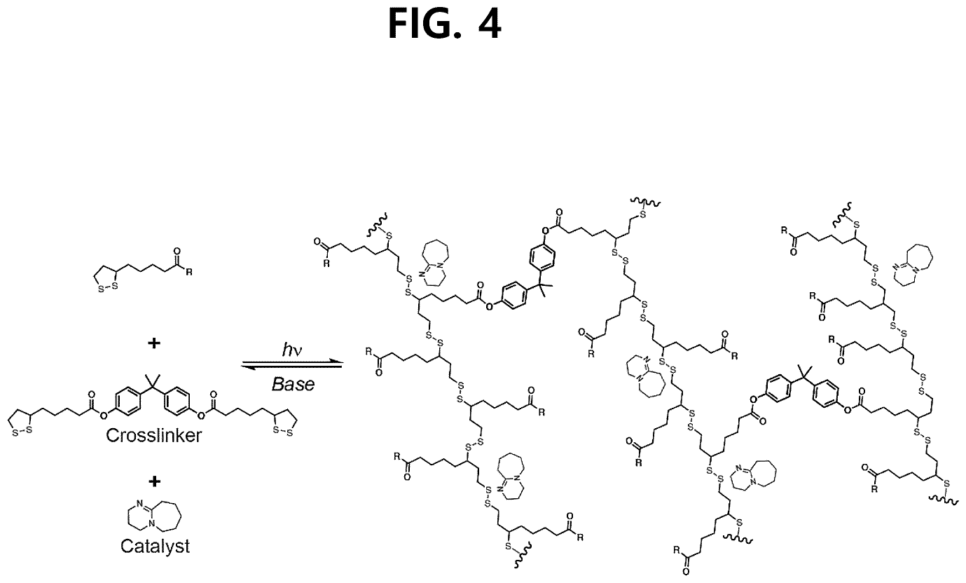

For example, the crosslinked polymer can be polymerized by mixing the dithiolane monomer synthesized as shown in FIG. 4 with the molecules containing the dithiolane group at both ends (the crosslinker).

Thereafter, 1,8-diazabicyclo[5.4.0]-7-undecane (DBU)) is added to the above-prepared crosslinked polymer to produce the crosslinked polymer having efficient self-healing and energy absorption properties by accelerating disulfide exchange.

In an embodiment, the method may further comprise the step of, before obtaining the crosslinked polymer, obtaining the compound represented by the formula 1-1 by reacting a lipoic acid with a compound represented by any one of the following formulas.

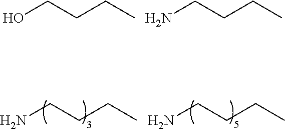

In an embodiment, the method may further comprise the step of, before obtaining the crosslinked polymer, obtaining the compound represented by the formula 2-1 by reacting a lipoic acid with bisphenol A.

In other words, according to an embodiment of the present disclosure, several derivatives having different side chain structures can be prepared based on one monomer (lipoic acid) using the same catalyst and additive, and the polymer can be relatively easily prepared using a visible light or a UV under the normal atmospheric condition. In addition, by controlling a degree of cross-linking, it is possible to prepare a polymer having various mechanical properties.

For example, the wavelength band of light used may be determined depending on which photoinitiator is used.

Another still exemplary embodiment, the present disclosure provides a method for recycling the above-described polymer compound, the method comprising the steps of:
dissolving the polymer compound in a solution containing an amine base; and
separating a compound represented by the formula 1-1 below and a compound represented by the formula 2-1 below from the above solution.

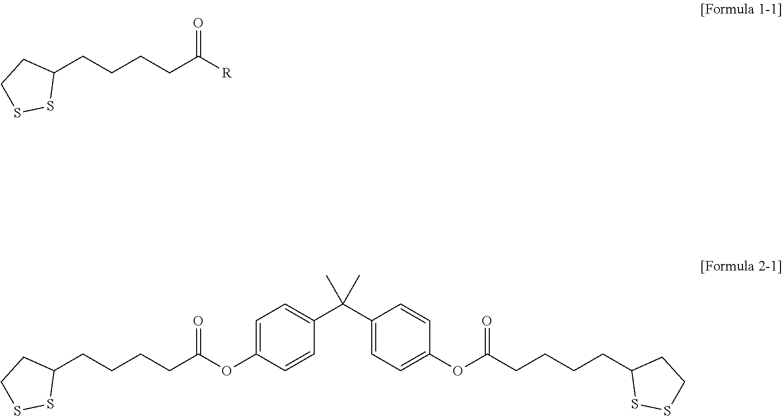

In the formula 1-1, R is represented by any one of the following formulas.

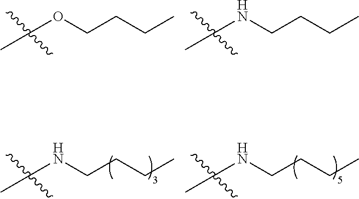

In an embodiment, as a solvent in the step of dissolving the polymer compound in a solution containing an amine base, a polar solvent may be used and may include halogenated hydrocarbon solvents such as CHCl₃, alcohols such as ethanol and methanol, ketones such as acetone, ethers such as THF, or any polar solvent that can dissolve the monomer, such as DCM.

If depolymerization occurs by controlling a content of the amine base such as DBU, restoration to the monomer and the crosslinker can be performed.

For example, the solution in which the above-mentioned polymer compound is completely dissolved can be obtained by separating it into the monomer (the compound represented by the formula 1-1) and the crosslinker (the compound represented by the formula 2-1) through column purification.

In another exemplary embodiment, the present disclosure provides a shock absorber comprising the above-described polymer compound.

The present disclosure is explained in more detail through the following Examples. However, since those Examples are to illustrate the present disclosure, the scope of the present disclosure is not limited only to Examples.

### EXAMPLE

As shown in FIG. 2, a compound represented by the formula 1-1 and a compound represented by the formula 2-1 were prepared as a parent of the polymer compound,

### Monomer: Compound Represented by Formula 1-1

[Monomer: BuLA] The synthesis method for each derivative is similar with each other, and the synthesis method for BuLA (butyl lipoate or butyl-5-(1,2-dithiolan-3-yl)pentanoate) is as follows:

1-(3-dimethylaminopropyl)-3-ethylcarbodiimide hydrochloride (EDCI, 2.56 g, 13.4 mmol, 1.1 equivalent) and 4-(dimethylamino)pyridine (DMAP, 0.15 g, 1.22 mmol, 0.1 equivalent) were added to a flask and purged with Ar. Dichloromethane (DCM, 30 ml) was added to the flask and stirred for 5 minutes, and butanol (1.11 ml, 12.1 mmol, 1 equivalent) was further added to the flask and stirred. When the solution reached a transparent state, a solution of lipoic acid (LA, 3.00 g, 14.5 mmol, 1.2 equivalent) dissolved in DCM (30 ml) was injected thereto and stirred at a room temperature for 24 hours. Upon completion of the reaction, a yellow viscous gel was obtained (yield: 95%).

[Monomer: BuLAm] The synthesis method of BuLAm (butyl lipoamide or N-butyl-5-(1,2-dithiolan-3-yl) pentanamide) is as follows:

1-(3-dimethylaminopropyl)-3-ethylcarbodiimide hydrochloride (EDCI, 3.07 g, 13.4 mmol, 1.1 equivalent) and 4-(dimethylamino)pyridine (DMAP, 0.18 g, 1.22 mmol, 0.1 equivalent) were added to a flask and purged with Ar. Acetonitrile (MeCN, 60 ml) was added to the flask and stirred for 5 minutes. Lipoic acid (LA, 3.00 g, 14.5 mmol, 1.0 equivalent) was dissolved in MeCN (30 mL), mixed with the solution prepared above, and stirred for 30 minutes. Thereafter, butylamine (2.2 ml, 21.8 mmol, 1.5 equivalent) was slowly injected into the flask in which the above solution was being stirred, and stirred at a room temperature for 24 hours. When the reaction was completed, a final material was obtained by separation using a column chromatography (yield: 94%).

[Monomer: OcLAm] The synthesis method of OcLAm (octyl lipoamide or N-butyl-5-(1,2-dithiolan-3-yl)octylpentanamide) is as follows:

1-(3-dimethylaminopropyl)-3-ethylcarbodiimide hydrochloride (EDCI, 3.07 g, 13.4 mmol, 1.1 equivalent) and 4-(dimethylamino)pyridine (DMAP, 0.18 g, 1.22 mmol, 0.1 equivalent) were added to a flask and purged with Ar. DCM (60 ml) was added to the flask and stirred for 5 minutes. Lipoic acid (LA, 3.00 g, 14.5 mmol, 1.0 equivalent) was dissolved in DCM (30 mL), mixed with the solution prepared above, and stirred for 30 minutes. Thereafter, octylamine (3.6 ml, 21.8 mmol, 1.5 equivalent) was slowly injected into the flask in which the above solution was being stirred, and stirred at a room temperature for 24 hours. When the reaction was completed, a final material was obtained by separation using a column chromatography (yield: 92%).

[Monomer: DdLAm] The synthesis method of DdLAm (dodecyl lipoamide or N-butyl-5-(1,2-dithiolan-3-yl) dodecylpentanamide) is as follows:

1-(3-dimethylaminopropyl)-3-ethylcarbodiimide hydrochloride (EDCI, 3.07 g, 13.4 mmol, 1.1 equivalent) and 4-(dimethylamino)pyridine (DMAP, 0.18 g, 1.22 mmol, 0.1 equivalent) were added to a flask and purge with Ar. DCM (40 ml) was added to the flask and stirred for 5 minutes. Lipoic acid (LA, 3.00 g, 14.5 mmol, 1.0 equivalent) was dissolved in DCM (30 mL), mixed with the solution prepared above, and stirred for 30 minutes. Thereafter, dodecylamine (2.94 g, 21.8 mmol, 1.5 equivalent) was dissolved in DCM (30 ml), slowly injected into the flask in which the above solution was being stirred, and stirred at a room temperature for 24 hours. When the reaction was completed, a final material was obtained by separation using a column chromatography (yield: 86%).

[Crosslinker: Compound represented by formula 2-1] Bisphenol A (0.5 g, 2.19 mmol, 1 equivalent), EDCI (1.85 g, 9.65 mmol, 2.2 equivalent), and DMAP (0.11 g, 0.90 mmol, 0.2 equivalent).) were placed in a round flask and purged with Ar. Acetonitrile (MeCN, 30 ml) was added to the flask and stirred for 5 minutes. Thereafter, LA (1.13 g, 5.48 mmol, 2.5 equivalent) dissolved in MeCN (10 ml) was added to the reaction vessel and stirred at a room temperature for 24 hours. A yellow powder was obtained by purifying the reactants with a column (1.22 g, 2.01 mmol, 92%).

Then, as shown in FIG. 3, phenylbis(2,4,6-trimethylbenzoyl) phosphine oxide (BAPO) was used as a photoinitiator, and a content of the photoinitiator equivalent to 3 mol % compared to the monomer and the monomer (1 g) were placed in the reaction vessel. After DCM (2 mL) was added to the reaction vessel and mixed uniformly, they were heated at 80° C. for about 1 hour. Once all solvents were removed, polymerization was performed by treatment under a LED lamp (intensity of about 70 mW/cm²) for 30 minutes. Unreacted monomers were removed through precipitation (using ethanol for BuLA, diethyl ether for BuLAm and OcLAM, and methanol for DdLAm, as a precipitation solvent), and a finally obtained polymer was dried in a vacuum oven.

Thereafter, as shown in FIG. 4, the synthesized dithiolane monomer and molecules containing a dithiolane group at both ends were mixed to polymerize a crosslinked polymer.

A method for preparing a sample with a cross-linking density of 5 mol % using BuLA monomer (xPBuLA) is introduced as an example, and a method similar to this can be applied by using other monomers or controlling the cross-linking density. BuLA (butyl lipoate, butyl 5-(1,2-dithiolan-3-yl)pentanoate) (0.3 g, 1.143 mmol, 1 equivalent.), BPA-LA (propane-2,2-diylbis(4, 1-phenylene)-bis(5-(1,2-dithiolan-3-yl)pentanoate) (0.035 g, 0.058 mmol, 0.05 equivalent.), and BAPOs (0.015 g, 0.036 mmol, 0.03 equivalent) were placed in a vessel, and DCM (0.5 ml) was added thereto and mixed uniformly. The final solution was poured into a mold and treated in an oven at 60° C. for 2 hours. When the solvent was completely removed, the solution was cross-linked under a white LED lamp (intensity of about 70 mW/cm²) for 30 minutes. In order to further treat DBU, an appropriate amount of DBU was dissolved in DCM, and then the solution was dropped on a surface of the crosslinked polymer and waited until the solution was completely evaporated.

### EXPERIMENT EXAMPLE

### Experimental Example 1

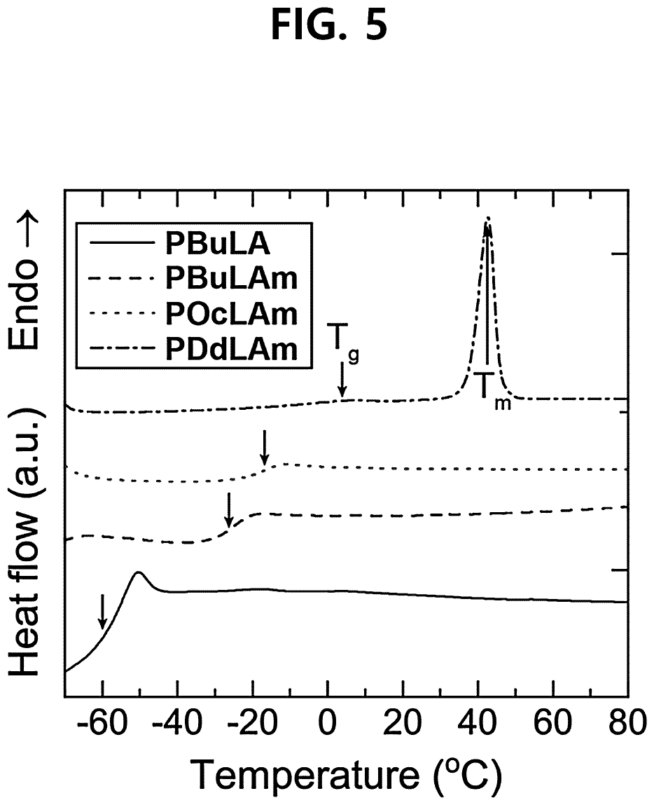

As shown in FIG. 5, a glass transition temperature (Tg) of the polymer compound prepared in Example was observed.

It was observed that when PBuLA(poly(butyl lipoate)) and PBuLAm(poly(butyl lipoamide)) have the same length of aliphatic chains, PBuLAm had a high glass transition temperature (Tg) that can form hydrogen bonds, and that if they had the same hydrogen bonds, the glass transition temperature (Tg) was also increased as a length of the aliphatic chains was increased. Also, crystalline was formed from more than 12 carbons in the side chains, and melting point (Tm) of the crystal appeared.

### Experimental Example 2

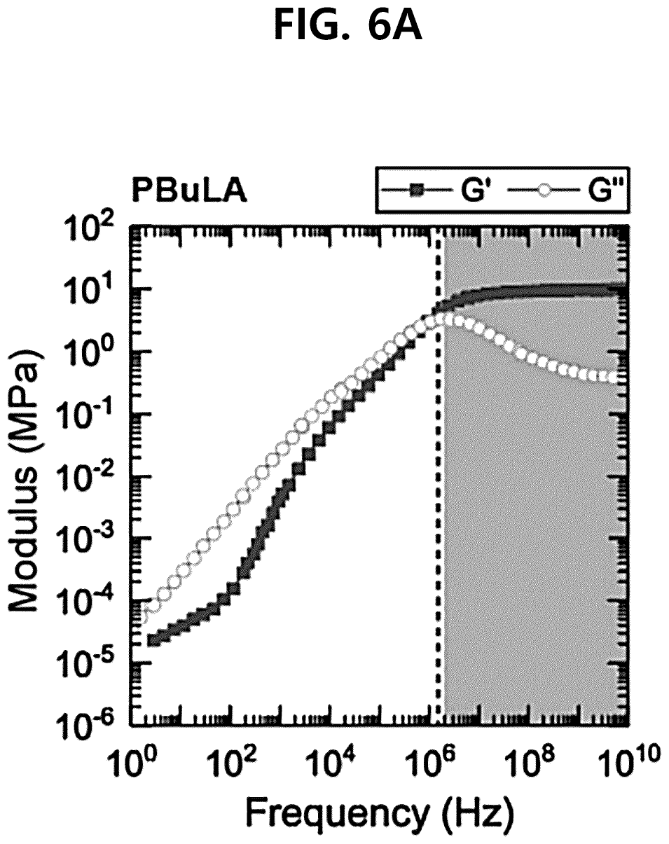

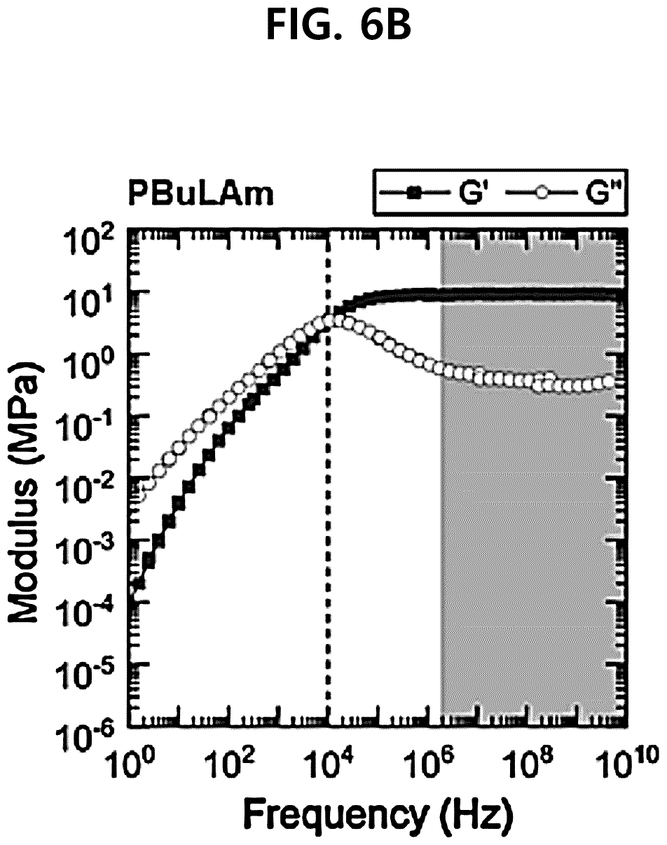

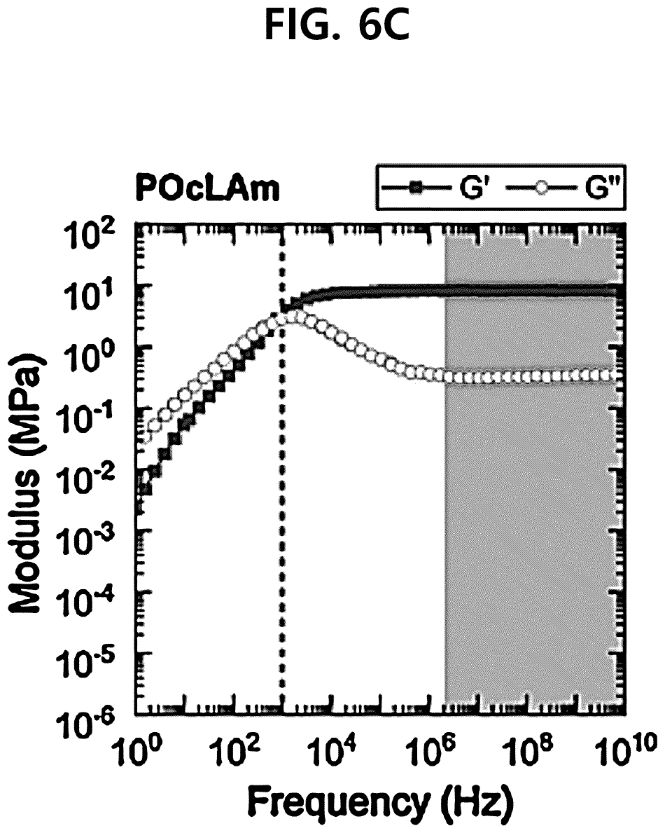

As shown in FIGS. 6A to 6C, rheological properties of the polymer compound prepared in Example were observed. Specifically, the rheological properties were examined at very high frequencies corresponding to 1 Hz to 10¹⁰ Hz using a time-temperature superposition (TTS) method.

PDdLAm, a semi-crystalline polymer, was not measured because it was difficult to apply the TTS method, and measurement was performed on the remaining three polymer compounds, which were amorphous polymers.

At a high frequency band (2 MHz or more) corresponding to a shock wave, a storage modulus (G′) appeared similar regardless of the samples, but a point where G′ and loss modulus (G″) were intersected occurred at lower frequencies as the chains became longer. In other words, it was confirmed that the intersection point for PBuLA appeared at the region of about 1 MHZ, the intersection point for PBuLAm appeared at the region of 10 kHz, and the intersection point for POcLAm (poly (octyl lipoamide)) appeared at the region of 1 kHz.

### Experimental Example 3

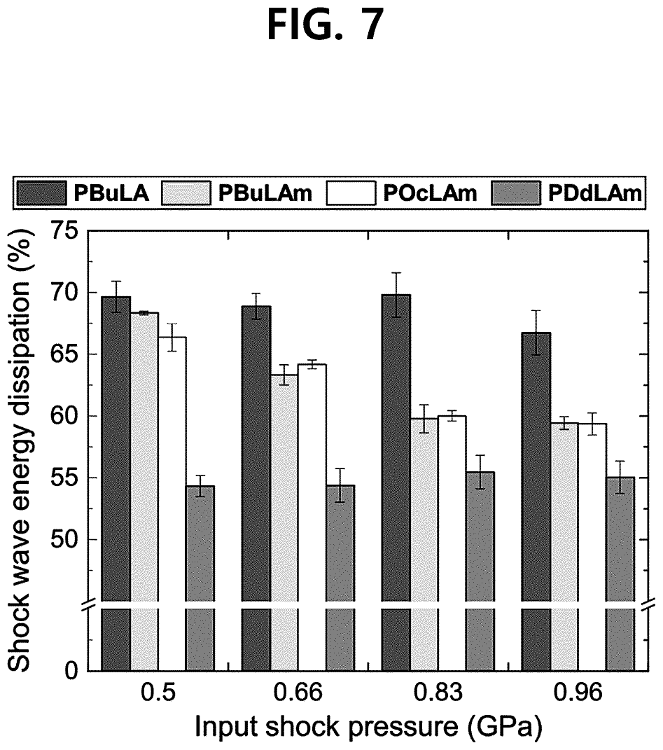

As shown in FIG. 7, shock wave absorption characteristics of the polymer compound prepared in Example were observed.

A preparation of specimens for absorbing the shock wave is as follows:

First, a polymer material is applied to a thickness of 50 microns between glass substrates, and then the surfaces of both glass substrates are deposited with aluminum (400 nm on a top and 200 nm on a bottom) through electron beam evaporation. A sodium silicate solution is applied to the top of the prepared sample to form an additional layer having a thickness of 7 microns.

The prepared specimen generates a shock wave by irradiating a high-power laser as follows:

First, when a Q-switched laser pulse (λ=1064 nm, CNI lasers LPS 1064-L 700 mJ) is irradiated to the top layer of the sample, the aluminum layer is heated and an explosion occurs through plasmaization. However, the sodium silicate layer additionally applied to the upper layer prevents the upper aluminum layer from being detached, which results in occurrence of a longitudinal wave. Intensity of the shock wave is determined by intensity of the laser, and it is possible to calculate how much shock wave energy has been absorbed into the shock wave absorption layer by measuring a moving distance of the sample when the shock wave is generated.

PDdLAm (poly(dodecyl lipoamide)), a semi-crystalline polymer, showed the lowest shock wave absorption characteristics, and the remaining amorphous polymers generally showed shock wave absorption ability close to 60%, and at a frequency band similar to the shock wave, P BuLA, where rubbery-to-glassy transition occurs, showed the highest absorption characteristics.

### Experimental Example 4

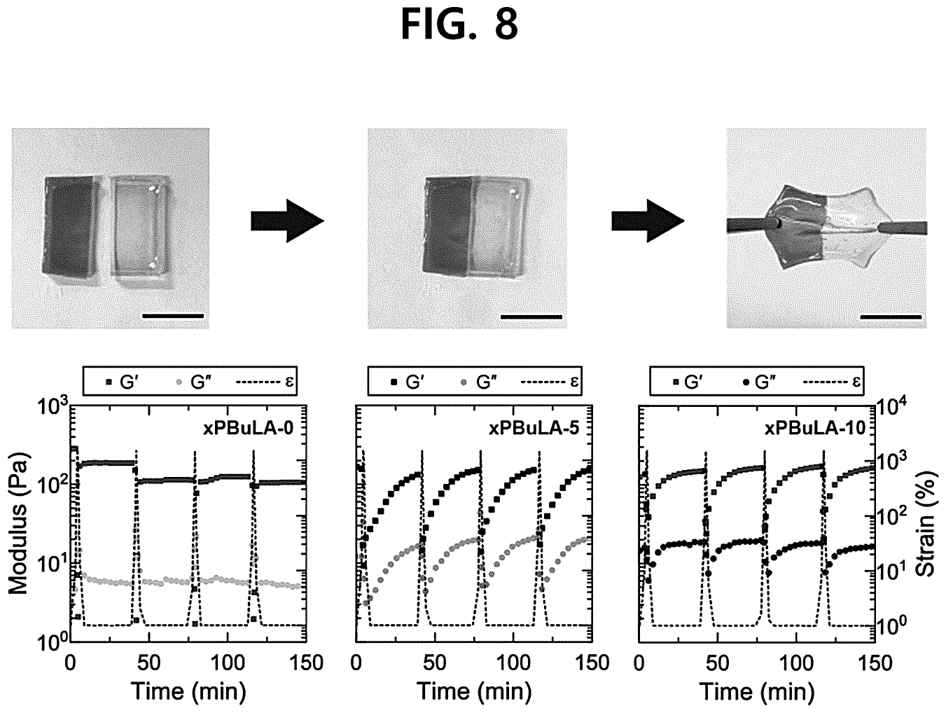

As shown in FIG. 8, self-healing characteristics of the compound prepared in Example were observed by varying contents of DBU. It was confirmed that the crosslinked polymer dramatically increased the self-healing characteristics depending on whether or not DBU was contained.

After two sheets of the crosslinked polymers having the same components were prepared, a film of the one sheet was stained with rhodamine dye for distinguish each other (red film). After the two films were cut with a knife, each piece thereof was collected, when the cut cross sections were brought into contact with each other and a pressure was applied for 30 minutes, the damaged area was completely bonded and did not break even when pulled again.

Specifically, a cyclic strain sweep experiment was conducted using a rheometer (MCR 302e, Anton Paar). A modulus was measured by fixing the frequency at 1 Hz and applying a 1% strain to the sample, and a change in the modulus was examined by increasing the strain to 1500%. Thereafter, the strain was reduced to 1% again to observe for 30 minutes how much modulus recovered. This process was repeated 4 times.

As a result of the observation, as shown in the top photo of FIG. 8, it was confirmed that the crosslinked polymer to which about 10 wt % of DBU was added was self-healed even at a room temperature within 30 minutes. As a result of checking the self-healing characteristics with a rheometer, it was confirmed that the original mechanical properties were completely restored within 30 minutes when DBU was added 5 wt % or more.

### Experimental Example 5

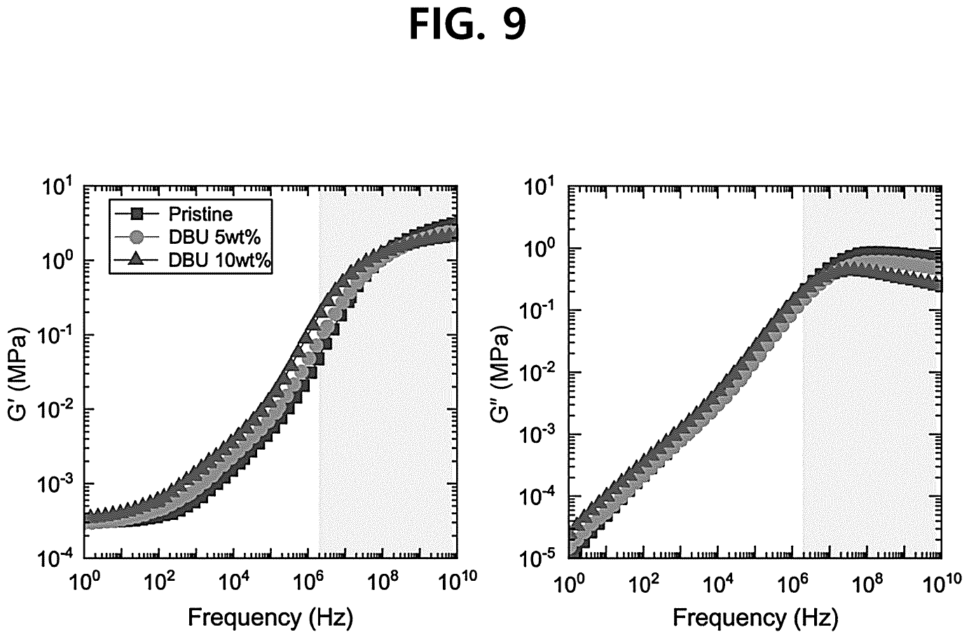

As shown in FIG. 9, G′ and G″ values according to DBU contents of the polymer compound prepared in Example were observed. The concerned compound is xPBuLA, wherein BuLA is a crosslinked polymer composed of monomers and a ratio of BPA-LA as the crosslinker is 5 mol %.

A frequency sweep experiment was conducted at various temperature zones using a rheometer (MCR 302e, Anton Paar). The frequency was tested in the range of 0.1 to 10 Hz, and the temperature range was limited within −70 to 100° C. The frequency sweep results obtained at each temperature zone were used to obtain master curves through a time-temperature superposition method.

The very similar G′ and G″ values were shown regardless of the DBU contents, and the frequency zones where the rubbery to glassy transition occurs were confirmed to be almost the same. The sample no containing DBU was marked as pristine. It can be inferred that improvement of the shock wave absorption properties due to DBU was caused by a more active exchange reaction of disulfide rather than a change in the mechanical properties of the material.

### Experimental Example 6

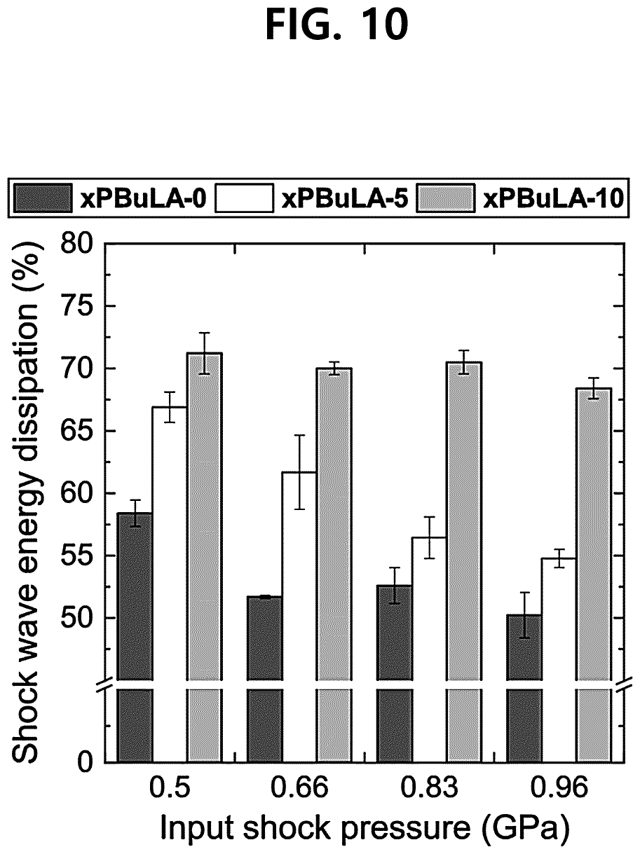

As shown in FIG. 10, the shock wave absorption characteristics were observed in the same method as in Experimental Example 2 by varying DBU contents of the crosslinked compound (xPBuLA-0) prepared in Example.

The shock wave absorption characteristics showed very large differences depending on the DBU contents. Specifically, the sample containing 5 wt % of DBU (xPBuLA-5) showed the shock wave absorption characteristics improved by up to 20%, compared to the sample without DBU, and the sample containing 10 wt % of DBU (xPBuLA-10) showed the improved absorption characteristics of 35% or more.

Such results are believed to be for the reason that DBU was able to absorb the shock wave more effectively by lowering activation energy of the disulfide exchange reaction to allow a faster exchange reaction to occur even at a room temperature.

### Experimental Example 7

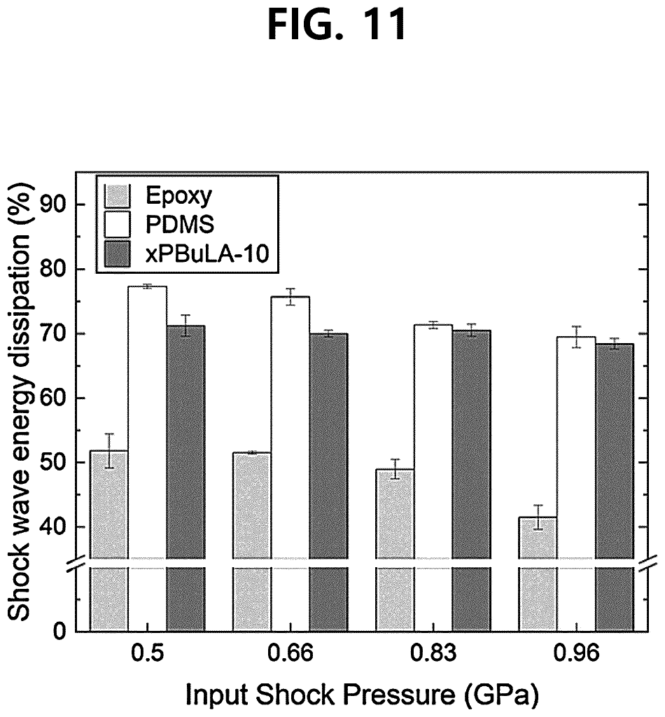

As shown in FIG. 11, the shock wave absorption performances between the polymer compound (xPBuLA-10) prepared in Example and previously known shock wave-absorbing materials (PDMS is a sylgard 184 product and epoxy is a Kukdo chemical product) were measured and compared in the same method as in Experimental Example 2.

It was confirmed that the polymer compound exhibited very high absorption characteristics compared to those of the commonly used epoxy and had the high absorption characteristics corresponding to PDMS (polydimethylsiloxane). Nevertheless, the polymer compound according to this Example is expected to have higher availability because it has self-healing properties that are not present in PDMS.

### Experimental Example 8

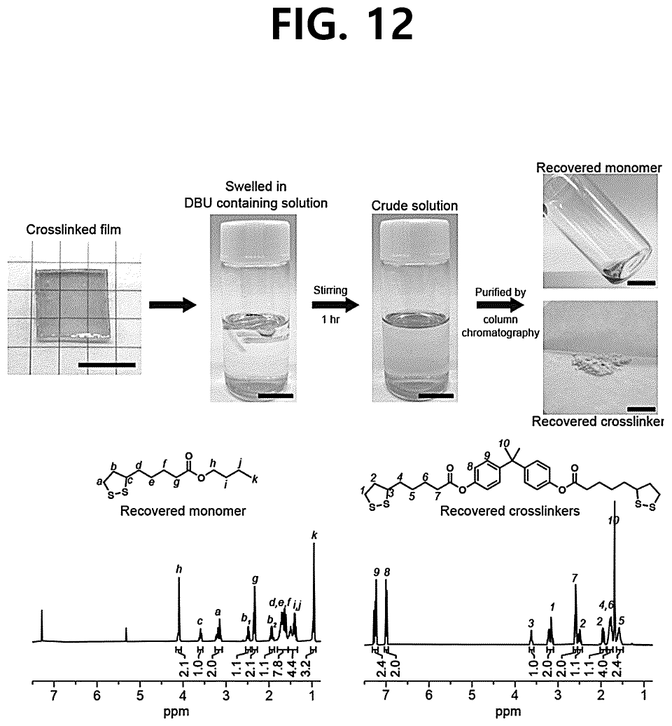

As shown in FIG. 12, the polymer compound prepared in Example (xPBuLA) was restored to a monomer and a crosslinker.

If 50 mg of the crosslinked polymer is immersed in a DBU solution (15 mg in 10 mL of DCM) and stirred for 1 hour, the crosslinked polymer is gradually dissolved. When the polymer is completely dissolved, it can be separated into the monomer and the crosslinker through a column chromatography.

It was confirmed that in case a concentration of DBU is increased to 20 wt % or more (DBU 15 mg/DCM 10 mL), depolymerization occurs to make it possible to restore to the monomer. The solution in which the polymer is completely dissolved can be separated into the monomer and the crosslinker through column purification, and they were confirmed to have a purity of 99% or more through NMR.

### STATEMENT REGARDING PRIOR DISCLOSURE BY THE INVENTOR OR A JOINT INVENTOR

The sixth inventor (LEE, Dongju) of the present application has made the following related disclosure: “Side chain engineering of dynamic poly (disulfide) s for efficient shockwave energy dissipation,” Master's Thesis, The Graduate School Sungkyunkwan University, Feb. 1, 2024. The related disclosure was made less than one year before the effective filing date (May 22, 2024) of the present application. Accordingly, the related disclosure is grace period inventor disclosure, and thus is disqualified from prior art under 35 U.S.C § 102(a)(1) against the present application. See 35 U.S.C § 102(b)(1)(A).

What is claimed is:

1. A polymer compound comprising:
a structural unit represented by the formula 1 below;
a structural unit represented by the formula 2 below; and
an amine base. 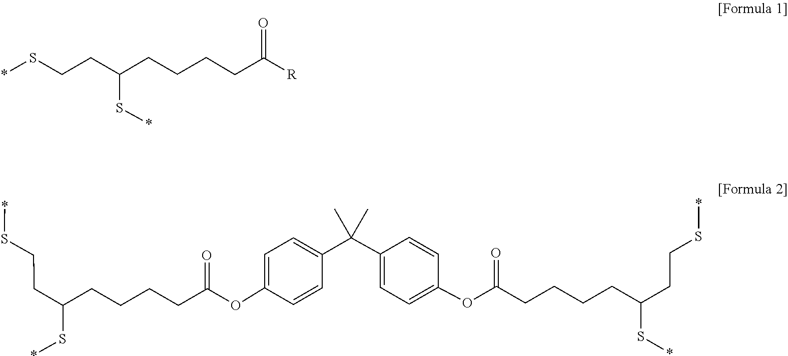
In the formula 1, R is represented by any one of the following formulas:

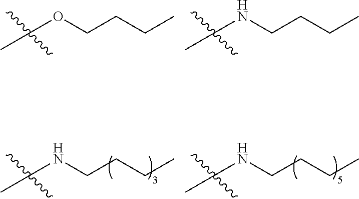

2. The polymer compound according to claim 1,
wherein the amine base is a bi-or polycyclic amine base.

3. The polymer compound according to claim 1,
wherein the amine base comprises one or more selected from the group consisting of 1,8-diazabicyclo[5.4.0]-7-undecane (DBU), 1,5-diazabicyclo[4.3.0]-5-nonene (DBN)), 1,4-diazabicyclo[2.2.2] octane (DABCO), 1,5,7-triazabicyclo[4.4.0] dec-5-ene (TBD), and 7-methyl-1,5,7-triazabicyclo[4.4.0]dec-5-ene (MTBD).

4. The polymer compound according to claim 1,
wherein a content of the amine base is 3% by weight or more based on the total weight of the polymer compound.

5. The polymer compound according to claim 1,
further comprising a photoinitiator.

6. The polymer compound according to claim 5,
wherein the photoinitiator comprises one or more selected from the group consisting of phenyl-bis(2,4,6-trimethylbenzoyl)-phosphine oxide, (2,4,6-trimethylbenzoyl)-diphenyl-phosphine oxide, phenyl-(2,4,6-trimethylbenzoyl)-phosphinic acid ethyl ester, bis-acylphosphine oxide, bis(2,6-dimethoxybenzoyl)-(2,4,4-trimethyl-pent-1-yl) phosphine oxide, bis(2,4,6-trimethylbenzoyl)-(2,4-dipentoxyphenyl)phosphine oxide, and trisacylphosphine oxide.

7. The polymer compound according to claim 1,
wherein the polymer compound is semi-crystalline or amorphous.

8. The polymer compound according to claim 1,
wherein the polymer compound is used to absorb a shock wave.

9. The polymer compound according to claim 1,
wherein the polymer compound is restored to its original mechanical properties within 30 minutes after applying mechanical shock.

10. A method for preparing the polymer compound according to claim 1, the method comprising the steps of:
obtaining a crosslinked polymer by mixing a compound represented by the formula 1-1 below with a compound represented by the formula 2-1 below; and
adding an amine base to the crosslinked polymer. 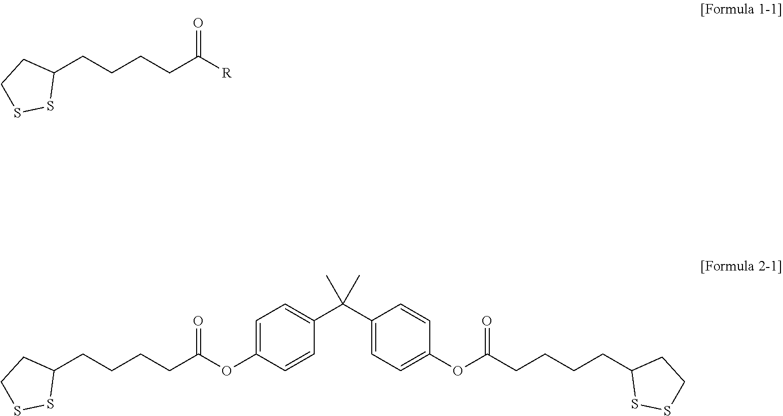
In the formula 1-1, R is represented by any one of the following formulas:

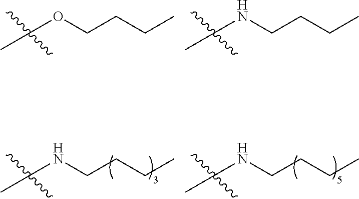

11. The method for preparing the polymer compound according to claim 10, further comprising the step of, before obtaining the crosslinked polymer, obtaining the compound represented by the formula 1-1 by reacting a lipoic acid with a compound represented by any one of the following formulas.

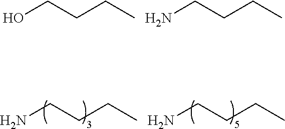

12. The method for preparing the polymer compound according to claim 10,
further comprising the step of, before obtaining the crosslinked polymer, obtaining the compound represented by the formula 2-1 by reacting a lipoic acid with bisphenol A.

13. A method for recycling the polymer compound according to claim 1, the method comprising the steps of:
dissolving the polymer compound in a solution comprising an amine base; and
separating a compound represented by the formula 1-1 below and a compound represented by the formula 2-1 below from the above solution. 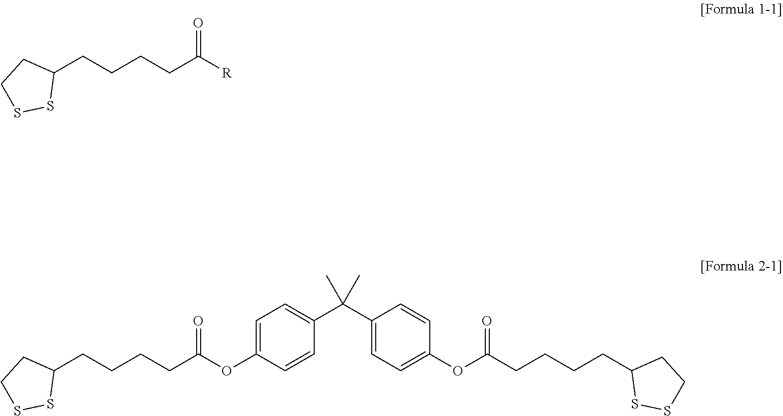
In the formula 1-1, R is represented by any one of the following formulas: [chemical structure]
